(19) United States
(12) Patent Application Publication
(10) Pub. No.: US 2025/0384170 A1
(43) Pub. Date: Dec. 18, 2025

(54) DATA PROCESSING DEVICE AND METHOD FOR ACTIVATING A SECURITY MODE OF A DATA PROCESSING DEVICE WITH A SCREEN

(71) Applicant: siOPTICA GmbH, Jena (DE)

(72) Inventor: Markus KLIPPSTEIN, Jena (DE)

(21) Appl. No.: 18/877,341

(22) PCT Filed: Jun. 28, 2023
(86) PCT No.: PCT/EP2023/067673

§ 371 Date: Dec. 20, 2024

(30) Foreign Application Priority Data
Jun. 30, 2022 (DE) 10 2022 116 315.6

(51) Int. Cl. G06F 21/84; G06F 40/279; G09G 3/20

(52) U.S. Cl. CPC G06F 21/84; G06F 40/279; G09G 3/20; G09G 2320/028; G09G 2320/0686; G09G 2358/00

(57) ABSTRACT

A method for activating a security mode of a data processing device with a screen, including the following steps: checking whether a file that has been opened or is to be opened in the data processing device, or its file name, contains at least one predefinable keyword and/or a predefinable security feature, activating the security mode of the data processing device if the checking method step turns out to be positive, wherein said activating the security mode means that at least one of the following steps is carried out: activating an audio warning signal, displaying a warning on the screen, dimming the brightness of the screen, switching on a warning luminaire on the data processing device and/or on the screen, and/or switching on an operating mode of the screen in which visibility is restricted. The invention furthermore relates to a corresponding data processing device.

### TECHNICAL FIELD OF THE INVENTION

Great advances have been achieved in recent years for widening the visual angle in LCDs. However, there are often situations in which this very large viewing area of a display screen can be disadvantageous. Increasingly, information such as bank data or other personal information and sensitive data are also available on mobile devices, such as notebooks and tablets. Accordingly, there is a need to supervise viewing access for these sensitive data. It must be possible to choose between a wide viewing angle—a public mode—for sharing information with others on a display, e.g., when viewing vacation photographs or for advertising purposes and, on the other hand, a small viewing angle—a private mode—when it is desirable to treat the displayed information confidentially.

However, users often act incautiously and completely forget to employ view protection.

A similar problem arises in the automotive industry. In this case, the driver must not be distracted by image contents, e.g., digital entertainment programs, while the engine is running, whereas the front seat passenger may want to enjoy such image contents during the drive. Consequently, there is a need for a display screen which can switch between the corresponding display modes.

Add-on films based on microlouvers have already been used for mobile displays in order to protect the privacy of data viewable on the display. However, these films were not switchable or toggleable; they always had to be manually applied first and then removed again subsequently. They also had to be carried separately from the display when not in use at the time. A further substantial drawback in the use of such louvered films relates to the light losses entailed.

### PRIOR ART

U.S. Pat. No. 6,765,550 B2 describes such a view protection by means of microlouvers. The greatest disadvantage here is the mechanical removal and mechanical mounting of the filter and the light losses in protected mode.

U.S. Pat. No. 5,993,940 A describes the use of a film which has small strip-shaped prisms arranged uniformly on its surface in order to achieve a privacy mode, i.e., a limited viewing mode with a small viewing angle area. The development and production are quite cumbersome in terms of technology.

In WO 2012/033583 A1, switching between public view and limited view is brought about by means of controlling liquid crystals between chromonic layers. There is light loss and the technical expenditure is quite high.

US 2012/0235891 A1 describes a very elaborate backlight in a display screen. According to FIGS. 1 and 15, not only is a plurality of light guides utilized but also further complex optical elements such as microlens elements 40 and prism structures 50 which reshape the light as it travels from the back illumination to the front illumination. This is expensive and technically complicated to implement and also involves light losses. According to the variant shown in FIG. 17 in US 2012/0235891 A1, both light sources 4R and 18 produce light with a narrow illumination angle, the light from the rear light source 18 first being transformed laboriously into light with a large illumination angle. This complex transformation sharply reduces brightness as already noted above.

According to JP 2007-155783 A, special optical surfaces 19 which are difficult to calculate and produce are used to deflect light in different narrow or broad areas depending on the incident angle of light. These structures resemble Fresnel lenses. Further, there are interference edges which deflect light in unwanted directions. Accordingly, it remains unclear whether or not meaningful light distributions can actually be achieved.

US 2013/0308185 A1 describes a special stepped light guide which emits light on a large area in various directions depending on the direction from which it is illuminated proceeding from a narrow side. Accordingly, in combination with a transmissive imaging display device, e.g., an LC display, a display screen can be produced that is switchable between a public viewing mode and a limited viewing mode. One of the drawbacks here consists in that the limited-view effect can only be produced for left and right or up and down, but not for left and right and up and down simultaneously as is needed for certain payment processes, for example. In addition to this, a residual light is also always still visible in the limited-view mode from blocked viewing angles.

WO 2015/121398 A1 by the present applicant describes a display screen with two operating modes in which scattering particles are present in the volume of the corresponding light guide for toggling between operating modes. However, the scattering particles selected therein, which comprise a polymerizate, generally have the disadvantage that light is coupled out of both large areas, as a result of which about one half of the useful light is emitted in the wrong direction, namely, toward the backlight, and cannot be recycled there to a sufficient extent because of the construction. Beyond this, the scattering particles of polymerizate which are distributed in the volume of the light guide can lead to scattering effects under certain circumstances, particularly at higher concentrations, and these scattering effects reduce the protected view effect in the private operating mode.

The methods and arrangements cited above generally share the disadvantage that they do not automatically adapt the view protection characteristics to the requirements of the application and also do not automatically activate the view protection when sensitive data are retrieved.

### DESCRIPTION OF THE INVENTION

Therefore, it is the object of the invention to describe a method for a data processing device and a data processing device with a display screen, which automatically detects when a view protection is necessary in as many relevant instances as possible based on the file contents to be displayed and/or on an associated security feature and then, as the case may be, automatically adapts its view protection characteristics. This is to be accomplished with simple means which are integrated in the system and do not require any actions on the part of the user such as pressing a toggle button.

This object is met according to the invention by a method for activating a security mode of a data processing device with a display screen, comprising the following steps:
checking whether or not a file that has been opened or is to be opened in the data processing device, or the filename thereof, contains at least one specifiable keyword (e.g., a word such as “private” or “confidential”) and/or a specifiable security feature,
activating the security mode of the data processing device when the above-mentioned checking method step has a positive result, and the activation of the security mode means that at least one of the following steps is carried out:
   activating an audio warning signal (generally temporarily),
   displaying a warning on the display screen (this can be for the duration of the display of the corresponding file or can be temporary, and the warning can be, for example, a superimposed or inserted text and/or an image and/or a video,
   dimming the brightness of the display screen (generally, this results in at least making it more difficult to view the display screen from the side),
switching on a warning light (if provided) at the data processing device and/or at the display screen, and/or
switching on an operating mode of the display screen in which the visibility is limited. (In this case, when this operating mode has already been switched on previously, it also remains switched on).

The limited visibility can advantageously depend on the viewing angle on the display screen. In case an operating mode of the display screen in which visibility is limited is switched on, an unrestricted visibility would remain in effect only for a selected user, such as the main user, who is positioned in front of the display screen. Other users with an oblique viewing angle would not be able to perceive the displayed contents or would at least not have an unlimited view of the displayed contents because of the limited visibility. The limited visibility can be achieved, for example, through modulation of the brightness curve over defined angular regions so that the brightness perceivable from oblique viewing angles is sharply reduced, which minimizes visibility.

Another possibility consists in blooming the displayed image contents substantially only in those viewing angles which should have a limited visibility.

Generally, the method provides that the described security mode of the data processing device is not activated or is deactivated after activation when the results of the above-mentioned checking are negative. This fact ensures that the described security mode is not normally in effect when no sensitive data have been opened or are to be opened.

The steps of the method are routinely executed periodically. Termination can be carried out when a termination condition is reached.

The specifiable security feature can be, for example, a specifiable bit sequence or byte sequence, particularly a determined code containing ASCII characters. Examples of this are the “PGP”, “pgp” security feature or a PGP key. When used in a vehicle, the security feature can also be a definable character sequence which indicates a content that is disruptive for the driver when driving, such as a film, a game or other moving images which are not associated with driving events. This above-mentioned definable character sequence can also relate to a file extension, such as “MPEG”, for example, or can otherwise be determined across all manufacturers to implement the invention. Other embodiments are also possible, of course.

Further, the security feature can also be obtained indirectly. For example, it may result from the findings of an image detection (i.e., by corresponding algorithms), for example, when the file that has been opened or is to be opened has a determined image content, such as a military symbol or a military device. In this example, a separate method step for image detection would be carried out for the file that has been opened or is to be opened which feedbacks the security feature to the checking step when predefined image contents are detected.

In a method described above in which the operating mode of the display screen of the data processing device with limited visibility is switched on in the security mode, the limited visibility is realized only in those areas of the display screen of the data processing device where the file that has been opened or is to be opened, or the filename thereof, which contains at least one specifiable keyword and/or a specifiable security feature is displayed. Other areas of the display screen then remain without limited visibility. This may be implemented with respect to the partial toggling of the operating mode, for example, using the teaching of PCT/EP 2021/076471, PCT/EP 2021/078013, PCT/EP 2021/058169 (serving herein as reference) of the present applicant, respectively, or, alternatively, through dual cell LCDs.

The object of the invention is also met by a data processing device comprising at least one processor, storage space and a display screen and, optionally, a loudspeaker and/or a warning light, wherein
the processor is controlled by control commands to check whether or not a file that has been opened or is to be opened, or the filename thereof, in the storage space of the data processing device contains at least one specifiable keyword (e.g., a word such as “private” or “confidential” or “internal”) and/or a specifiable security feature,
the processor is controlled by control commands to activate a security mode of the data processing device exactly when the above-mentioned checking method step has a positive result in that the processor executes at least one of the following steps and/or the data processing device is controlled such that it executes one of the following steps:
   when a loudspeaker is provided, activating an audio warning signal (generally temporarily, for example, a typical alarm sound),
   displaying a warning on the display screen (this can be for the duration of the display of the corresponding file or can be temporary, i.e., for a predeterminable time, e.g., 5 seconds, and the warning can be, for example, a superimposed or inserted text and/or an image and/or a video,
   dimming the brightness of the display screen,
   switching on a warning light (if provided) at the data processing device and/or at the display screen, and/or
   switching on an operating mode of the display screen in which the visibility is limited. (In this case, when this operating mode has already been switched on previously, it also remains switched on).

The data processing device according to the invention is advantageously configured to implement the above-described method according to the invention.

Further, it is preferably provided that the security mode of the data processing device is not activated or is deactivated after activation by the processor when the results of the above-mentioned checking by the processor are negative.

The processor routinely executes the above-mentioned steps periodically. This execution can be terminated when a termination condition is reached.

The specifiable security feature can be, for example, a specifiable bit sequence or byte sequence, e.g., a determined code containing ASCII characters. This security feature can be specified, for one, by one or more users and/or by the operating system of the data processing device.

However, a particular advantage of the invention is brought to light when the security feature determinative for the activation of the security mode is not known to the user of the data processing device or at least need not be entered. Rather, an application to be run on the processor can control the processor and the data processing device, respectively, to load a determined security feature for the aforementioned application from a server to carry out the above-described checking, followed by activation of the security mode as the case may be, when a file has been opened (or also after a file has been opened).

In this way, the programmers of a determined application can ensure the security step to be validated by means of the invention for determined applications or files.

Analogously, it is also possible to proceed with the specifiable keyword.

It is preferably provided that the display screen of the data processing device has at least two operating modes, in a first mode of which the visibility on the display screen is not limited, and in second mode of which the visibility on the display screen is limited. A limited visibility preferably means that the detectability of the display screen is appreciably reduced optically at least in determined angular regions, for example, through a sharp reduction of the perceivable brightness for such angular regions. For example, the angular regions can lie outside of a limit of approximately ±30° or ±45° (measured relative to the perpendicular bisectors of the display screen surface) in horizontal viewing direction of one or more viewers.

Other definitions are possible, such as also additionally or exclusively in vertical direction of one or more viewers.

Such a display screen which switches between operating modes can have a backlight which emits light selectively with at least two different selectable relative luminance distribution curves, which at least two relative luminance distribution curves are measured along a direction which is selectable but fixedly oriented with respect to the display screen. These operating modes can extend over the entire image area or only on selectable portions thereof.

Further, the display screen can have (additionally or instead of the backlight described above) a switchable optical component which can selectively influence the relative luminance distribution curve measured along a direction which is selectable but fixedly oriented with respect to the display screen. This switchable optical component comprises at least one of the following components: liquid crystals, electrochromic layers, photochromic layers, thermochromic layers, electrophoretic particles or magnetophoretic particles and/or electrowetting droplets.

For example, the display screen in this instance may be a display screen which comprises an above-mentioned switchable optical component located in front in viewing direction of a viewer or in the image reproduction unit (e.g., an LCD panel with backlight and corresponding control), which switchable optical component in turn comprises:
a first optical element which
   comprises a first layer, or a first layer and a plurality of further layers,
   wherein each layer comprises a material with a plurality of light-absorbing transition dipole moments,
   wherein each transition dipole moment is oriented, at least in a first state with a tolerance of a maximum of 10°, parallel to a first reference direction which is selectable for the first optical element or fluctuates around the latter,.
   such that light which is incident in the first optical element is transmitted or at least partially absorbed depending on its incident direction relative to the layers and its polarization state,
a polarization filter which is arranged upstream or downstream of the first optical element considered in incident direction,
means for selectively generating a first electric field or a second electric field,
a liquid crystal layer arranged between the first optical element and the polarization filter, this liquid crystal layer being acted upon by the first electric field or the second electric field and, depending thereon, influences the polarization state of light passing through it so that,
in a first operating mode B1 in which the first electric field is applied, with a first sub-operating mode B1H and a second sub-operating mode B1V, on the one hand, at least 24% of unpolarized light which is incident in the switchable light filter parallel to the first reference direction is transmitted and, on the other hand, at least 85% of unpolarized light which is incident in the switchable light filter in an angle of greater than 30° to the first reference direction is absorbed, wherein this absorption takes place exclusively along a first reference direction in the first sub-operating mode B1H and exclusively in a second reference direction perpendicular to the first reference direction in the second sub-operating mode B1V, in a second operating mode B2 in which the second electric field is applied, with the first sub-operating mode B1H and the second sub-operating mode B1V, on the one hand, at least 24% of unpolarized light which is incident in the switchable light filter parallel to the first reference direction is transmitted and, on the other hand, at least 85% of unpolarized light which is incident in the switchable light filter in an angle of greater than 30° with respect to the first reference direction is absorbed, wherein this absorption takes place exclusively in the second reference direction in the first sub-operating mode B1H and exclusively in the second reference direction perpendicular to the first reference direction in the second sub-operating mode B1V, so that the reference directions of absorption differ by 90°, respectively, for each of the two sub-operating modes B1H, B1V for the first operating mode B1 and the second operating mode B2.

The switchable optical components can advantageously be divided into a plurality of separately switchable segments so as to allow local switchability between the respective possible operating modes.

It is then possible in particular that the limited visibility is realized only on those areas of the display screen of the data processing device where the file that has been opened or is to be opened, or the filename thereof, which contains at least one specifiable keyword and/or one specifiable security feature is displayed. Other areas of the display screen on which no information requiring confidentiality is displayed remain visible for users other than the main user of the data processing device.

Depending on the application, the display screen may also be configured in such a way that the main user can view the image contents without limitation of visibility when located obliquely in front of the display screen rather than directly in front of the display screen even if the security mode should be activated.

In general, the data processing device with display screen can be a stationary PC or server with separate display screen or with a plurality of display screens (which are arranged in each instance individually, in groups or in their entirety within the meaning of the invention and correspondingly controlled), a laptop, a notebook, a smart phone or a tablet with integrated display screen, or any other applicable configuration.

Other embodiments for display screen configurations which are switchable between operating modes have already been mentioned in the description of the method according to the invention. They can be employed for the data processing device under discussion and will not be described in more detail to avoid redundancy.

The invention described above is advantageously used in offices, in passenger cars as well as with the use of mobile devices in transit or in public spaces.

The performance of the invention remains consistent in principle when the above-described parameters are varied within certain limits.

It will be understood that the features mentioned above and those yet to be explained below may be used not only in the stated combinations but also in other combinations or alone without departing from the scope of the present invention.

### BRIEF DESCRIPTION OF THE DRAWINGS

The invention will be explained in more detail in the following with reference to drawings which also disclose key features of the invention. These embodiment examples are provided merely to be illustrative and should not be considered as limiting. For example, a description of an embodiment example having a plurality of elements or components should not be interpreted to mean that all of these elements or components are necessary for its implementation. On the contrary, other embodiment examples may also contain alternative elements and components, fewer elements or components, or additional elements or components. Elements or components of different embodiment examples can be combined with one another unless otherwise stated. Modifications and alterations which are described for one of the embodiment examples may also be applicable to other embodiment examples. Like or comparable elements in the various figures are designated by the same reference numerals and not mentioned repeatedly so as to prevent repetition. The drawings show:

FIG. 1 a flowchart for an exemplary embodiment of the method;

FIG. 2 a schematic top view of a display screen of a data processing device from a plurality of directions, in this case with unrestricted visibility from all viewing directions;

FIG. 3 a schematic top view of a display screen of a data processing device from a plurality of directions, in this case with limited visibility from lateral viewing directions; and

FIG. 4 a schematic top view of a display screen of a data processing device from a plurality of directions, in this case with limited visibility from lateral viewing directions exclusively for a selected area of the display screen.

### DETAILED DESCRIPTION OF THE DRAWINGS

The drawings are not to scale and are merely schematic depictions.

FIG. 1 shows a flowchart for an exemplary configuration of a method for activating a security mode of a data processing device with a display screen, comprising the following steps:
checking whether or not a file that has been opened or is to be opened in the data processing device, or the filename thereof, contains at least one specifiable keyword (e.g., a word such as “private” or “confidential”) and/or a specifiable security feature,
activating the security mode of the data processing device when the above-mentioned checking method step has a positive result, and the aforementioned activation of the security mode means that at least one of the following steps, not shown in the drawings, is carried out:
   activating an audio warning signal (generally temporarily),
   displaying a warning on the display screen (this can be for the duration of the display of the corresponding file or can be temporary, and the warning can be, for example, a superimposed or inserted text and/or an image and/or a video,
   dimming the brightness of the display screen (generally, this results in at least making it more difficult to view the display screen from the side),
   switching on a warning light (if provided) at the data processing device and/or at the display screen, and/or
   switching on an operating mode of the display screen in which the visibility is limited. (In this case, when this operating mode has already been switched on previously, it also remains switched on).

Generally, the method provides that the described security mode of the data processing device is not activated or is deactivated after activation when the results of the above-mentioned checking are negative. This fact ensures that the described security mode is normally not in effect when no sensitive data have been opened or are to be opened.

The steps of the method are routinely executed periodically. Termination can be carried out when a termination condition is reached. The termination condition may consist, for example, in switching off the data processing device.

The specifiable security feature can be, for example, a specifiable bit sequence or byte sequence, particularly a determined code containing ASCII characters. Examples of this are the “PGP”, “pgp” security feature or a PGP key. When used in a vehicle, the security feature can also be a definable character sequence which indicates a content that is disruptive for the driver when driving, such as a film, a game or other moving images which are not associated with driving events. Other embodiments are also possible, of course.

Limited visibility can advantageously be configured depending on the viewing angle on the display screen. In case an operating mode of the display screen in which the visibility is limited is switched on, an unimpaired visibility would advantageously exist only for a selected user, such as the main user, situated e.g., in front of the display screen. Other users with an oblique viewing angle would be able to perceive the displayed contents not at all or at least not unrestrictedly because of the limited visibility. The limited visibility can be achieved, for example, through modulation of the brightness curve over defined angular regions so that the perceivable brightness is sharply reduced from oblique viewing angles, which minimizes visibility.

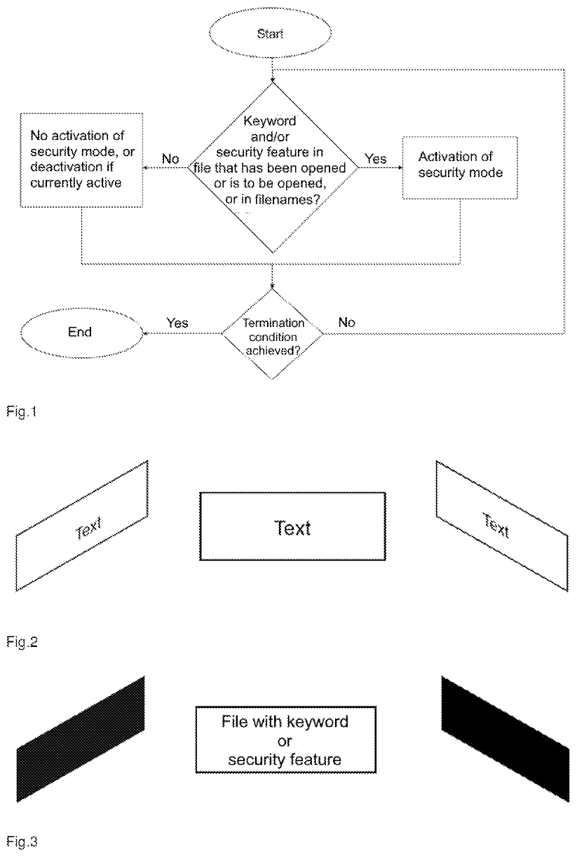

In this respect, FIG. 2 is a schematic top view of a display screen of a data processing device from a plurality of directions, in this instance with unrestricted visibility from all viewing directions. Provided the results of checking whether or not a file that has been opened or is to be opened in the data processing device, or the filename thereof, contains at least one specifiable keyword and/or a specifiable security feature are negative, that is, if the security mode is not activated, the display screen, shown here schematically, remains visible from all directions (from the left-hand side, from the front, and from the right-hand side), which is indicated by the legible lettering “text”.

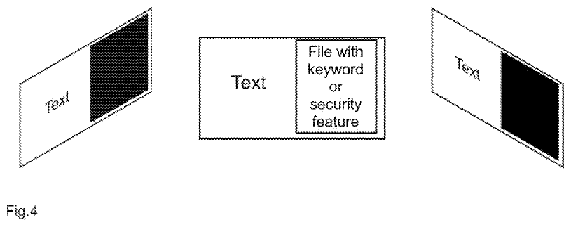

If, on the other hand, the results of the above-mentioned checking are positive, i.e., the security mode is activated, specifically in this instance by means of limited visibility, the file (i.e., the contents and/or title thereof) with the relevant keyword or security feature is only visible from a limited angular region, preferably for a main user situated in front of the display screen. This situation is depicted in FIG. 3 in a schematic top view of a display screen of a data processing device from a plurality of directions, in this instance with limited visibility from lateral viewing directions. Viewed from the front in the center, the visibility is good as is indicated in FIG. 3. On the other hand, from oblique viewing angles (e.g., under 30° or 45° to the perpendicular bisectors on the left-hand side and right-hand side), information can no longer be read because of the limited visibility, which is indicated here by the black image contents.

Further, FIG. 4 shows a schematic top view of a display screen of a data processing device from a plurality of directions, in this instance with limited visibility from lateral viewing directions exclusively for a selected area of the display screen. Specifically, in a method described above in which the operating mode of the display screen of the data processing device is switched on with limited visibility in the security mode, the limited visibility is advantageously realized only on those areas of the display screen of the data processing device where the file that has been opened or is to be opened, or the filename thereof, containing at least one specifiable keyword and/or a specifiable security feature is displayed. This is indicated in FIG. 4 by the partial area of the display screen which is readable when viewed from the front (“file with keyword or security feature”) but is displayed in black from lateral viewing angles on the left-hand side and right-hand side. Other areas on the display screen then remain without limited visibility, which is indicated by the lettering “text”. This may be implemented with respect to the partial toggling of the operating mode, for example, using the teaching of PCT/EP 2021/076471, PCT/EP 2021/078013, PCT/EP 2021/058169 (serving herein as reference) of the present applicant, respectively, or, alternatively, through dual cell LCDs.

The illustrations in FIGS. 1 to 4 may also be referred to for the description of a data processing device. Such a data processing device comprises at least one processor, storage space and a display screen and, optionally, a loudspeaker and/or a warning light, wherein
the processor is controlled by control commands to check whether or not a file that has been opened or is to be opened, or the filename thereof, in the storage space of the data processing device contains at least one specifiable keyword (e.g., a word such as “private” or “confidential” or “internal”) and/or a specifiable security feature,
the processor is controlled by control commands to activate a security mode of the data processing device exactly when the above-mentioned checking method step has a positive result in that the processor executes at least one of the following steps and/or the data processing device is controlled such that it executes one of the following steps:
   when a loudspeaker is provided, activating an audio warning signal (generally temporarily, for example, a typical alarm sound),
   displaying a warning on the display screen (this can be for the duration of the display of the corresponding file or can be temporary, i.e., for a predeterminable time, e.g., 5 seconds, and the warning can be, for example, a superimposed or inserted text and/or an image and/or a video,
   dimming the brightness of the display screen,
   switching on a warning light (if provided) at the data processing device and/or at the display screen, and/or
   switching on an operating mode of the display screen in which the visibility is limited. (In this case, when this operating mode has already been switched on previously, it also remains switched on).

The above-mentioned steps are routinely executed periodically. Termination can be carried out when a termination condition is reached.

FIG. 1 depicts a possible flowchart for (inter alia) control commands executing on the processor.

Further, it is preferably provided that the security mode of the data processing device is not activated by the processor or is deactivated after activation when the results of the checking by means of the above-mentioned processor are negative.

The specifiable security feature can be, for example, a specifiable bit sequence or byte sequence, e.g., a particular code containing ASCII characters.

The limited visibility can advantageously be configured depending on the viewing angle on the display screen. In case an operating mode of the display screen in which the visibility is limited is switched on, an unimpaired visibility would advantageously exist only for a selected user, such as the main user, situated e.g., in front of the display screen. Other users with an oblique viewing angle would be able to perceive the displayed contents not at all or at least not unrestrictedly because of the limited visibility. The limited visibility can be achieved, for example, through modulation of the brightness curve over defined angular regions so that the perceivable brightness is sharply reduced from oblique viewing angles, which minimizes visibility.

In this respect, FIG. 2 shows a schematic top view of a display screen of a data processing device from a plurality of directions, in this instance with unrestricted visibility from all viewing directions. Provided the results of checking whether or not a file that has been opened or is to be opened in the data processing device, or the filename thereof, contains at least one specifiable keyword and/or a specifiable security feature are negative, that is, if the security mode is not activated, the display screen, shown here schematically, remains visible from all directions (from the left-hand side, from the front, and from the right-hand side), which is indicated by the legible lettering “text”.

If, on the other hand, the results of the above-mentioned checking are positive, i.e., the security mode is activated, specifically in this instance by means of limited visibility, the file (i.e., the contents and/or title thereof) with the relevant keyword or security feature is only visible from a limited angular region, preferably for a main user situated in front of the display screen. This situation is depicted in FIG. 3 in a schematic top view of a display screen of a data processing device from a plurality of directions, in this instance with limited visibility from lateral viewing directions. Viewed from the front in the center, the visibility is good as is indicated in FIG. 3. On the other hand, from oblique viewing angles (e.g., under 30° or 45° to the perpendicular bisectors on the left-hand side and right-hand side), information can no longer be read because of the limited visibility, which is indicated here by the black image contents.

Such a display screen which switches between operating modes can have a backlight which emits light selectively with at least two different selectable relative luminance distribution curves, which at least two relative luminance distribution curves are measured along a direction which is selectable but fixedly oriented with respect to the display screen. These operating modes can extend over the entire image area or only on selectable portions thereof.

Further, the display screen can have (additionally or instead of the backlight described above) a switchable optical component which can selectively influence the relative luminance distribution curve measured along a direction which is selectable but fixedly oriented with respect to the display screen. This switchable optical component comprises at least one of the following components: liquid crystals, electrochromic layers, photochromic layers, thermochromic layers, electrophoretic particles or magnetophoretic particles and/or electrowetting droplets.

Further, FIG. 4 shows a schematic top view of a display screen of a data processing device from a plurality of directions, in this instance with limited visibility from lateral viewing directions exclusively for a selected area of the display screen. Specifically, in a method described above in which the operating mode of the display screen of the data processing device is switched on with limited visibility in the security mode, the limited visibility is advantageously realized only on those areas of the display screen of the data processing device where the file that has been opened or is to be opened, or the filename thereof, containing at least one specifiable keyword and/or a specifiable security feature is displayed. This is indicated in FIG. 4 by the partial area of the display screen which is readable when viewed from the front (“file with keyword or security feature”) but is displayed in black from lateral viewing angles on the left-hand side and right-hand side. Other areas on the display screen then remain without limited visibility, which is indicated by the lettering “text”. This may be implemented with respect to the partial toggling of the operating mode, for example, using the teaching of PCT/EP 2021/076471, PCT/EP 2021/078013, PCT/EP 2021/058169 (serving herein as reference) of the present applicant, respectively, or, alternatively, through dual cell LCDs.

The data processing device with display screen can be, e.g., a laptop.

The invention described above is advantageously used in offices, in passenger cars as well as with the use of mobile devices in transit or in public spaces.

The object of the invention has been met in that a method has been described for a data processing device and a data processing device with a display screen has been described which, in relevant instances, based on the file contents to be displayed and/or an associated security feature, automatically detects the need for privacy viewing and then correspondingly automatically adapts its privacy view properties. This is accomplished with simple means which are integrated in the system and do not require any actions on the part of the user such as pressing a toggle button.

1. A method for activating a security mode of a data processing device with a display screen, comprising the following steps:
checking whether or not a file that has been opened or is to be opened in the data processing device, or the filename thereof, contains at least one specifiable keyword and/or a specifiable security feature,
activating the security mode of the data processing device when the checking method step has a positive result, wherein the activation of the security mode means that at least one of the following steps is carried out:
activating an audio warning signal,
displaying a warning on the display screen,
dimming the brightness of the display screen,
switching on a warning light at the data processing device and/or at the display screen, and/or
switching on an operating mode of the display screen in which the visibility is limited.

2. The method according to claim 1, wherein the security mode of the data processing device is not activated or is deactivated after activation when the results of the above-mentioned checking are negative.

3. The method according to claim 1, wherein the specifiable security feature is a specifiable bit sequence or byte sequence.

4. The method according to claim 1, wherein the operating mode of the display screen of the data processing device is switched on with limited visibility in the security mode, wherein the limited visibility is realized only on those areas of the display screen of the data processing device where the file that has been opened or is to be opened, or the filename thereof, containing at least one specifiable keyword and/or a specifiable security feature is displayed.

5. A data processing device comprising at least one processor, storage space and a display screen and, optionally, a loudspeaker and/or a warning light, wherein
the processor is controlled by control commands to check whether or not a file that has been opened or is to be opened, or the filename thereof, in the storage space of the data processing device contains at least one specifiable keyword and/or a specifiable security feature,
the processor is controlled by control commands to activate a security mode of the data processing device exactly when the checking method step has a positive result in that the processor executes at least one of the following steps and/or the data processing device is controlled such that it executes one of the following steps:
when a loudspeaker is provided, activating an audio warning signal,
displaying a warning on the display screen,
dimming the brightness of the display screen,
switching on a warning light at the data processing device and/or at the display screen, and/or
switching on an operating mode of the display screen in which the visibility is limited.

6. The data processing device according to claim 5, wherein the security mode of the data processing device is not activated by the processor or is deactivated after activation when the aforementioned results of the checking by the processor are negative.

7. The data processing device according to claim 5, wherein the specifiable security feature is a specifiable bit sequence or byte sequence.

8. The data processing device according to claim 5, wherein the display screen has at least two operating modes, wherein, in a first mode, the visibility on the display screen is not limited and, in second mode, the visibility on the display screen is limited.

9. The data processing device according to claim 8, wherein the display screen of the data processing device has a backlight which emits light selectively with at least two different selectable relative luminance distribution curves, wherein the at least two relative luminance distribution curves are measured along a direction which is selectable but fixedly oriented with respect to the display screen.

10. The data processing device according to claim 8, wherein the display screen of the data processing device has a switchable optical component which can selectively influence the relative luminance distribution curve measured along a direction which is selectable but fixedly oriented with respect to the display screen, wherein this switchable optical component comprises at least one of the following components: liquid crystals, electrochromic layers, photochromic layers, thermochromic layers, electrophoretic particles or magnetophoretic particles and/or electrowetting droplets.

11. The data processing device according to claim 8, wherein the operating mode of the display screen of the data processing device is switched on with limited visibility in the security mode, wherein the limited visibility is realized only on those areas of the display screen of the data processing device where the file that has been opened or is to be opened, or the filename thereof, containing at least one specifiable keyword and/or a specifiable security feature is displayed.
